(19) United States
(12) Patent Application Publication
(10) Pub. No.: US 2005/0034548 A1
(43) Pub. Date: Feb. 17, 2005

(54) Radial drive propulsion system

(76) Inventors: Joseph G. Bolling, Omaha, NE (US); Thomas E. Bolling, Marshall, MO (US)

Correspondence Address: LAW OFFICES OF ADAM H. JACOBS, SUITE 726, 1904 FARNAM STREET, OMAHA, NE, 68102, US

(21) Appl. No.: 10/638,595

(22) Filed: Aug. 11, 2003

(51) Int. Cl. F16H 35/00

(52) U.S. Cl. 74/84 S

(57) ABSTRACT

A radial drive propulsion system for devices includes a base frame and a rotatably mounted drive shaft mounted on the base frame. The radial propulsion unit includes a generally perpendicularly extending drive arm mounted on the drive shaft and a translation arm mounted on the outer end of the drive arm, the translation arm extending generally inwards and forwards from the drive arm. A swivel-mounted oscillator unit includes a rotatably mounted generally upright oscillator unit base, the forward end of the translation arm being pivotably connected to the oscillator unit base. The oscillator unit further includes an oscillator arm mounted on and extending forwards from the generally upright propulsion unit base on which is mounted an oscillator weight. The drive shaft, the drive arm, the translation arm and the oscillator unit all cooperate to translate the rotary energy of the drive shaft into radial energy of the radial propulsion unit.

### BACKGROUND OF THE INVENTION

1. Technical Field

This invention relates to propulsion systems and, more particularly, to a radial drive propulsion system which includes a drive motor, at least one radial propulsion unit including a drive arm, a translation arm extending forwards and inwards from the drive arm, and an oscillator unit having a swivel base and oscillator arm and weight extending forwards from the swivel base and a gearbox section for transferring power from the drive motor to the drive arm of the radial propulsion unit such that rotation of the drive arm is translated by the translation arm and oscillator unit into radial motion of the oscillator arm thus producing radial force for propelling the device on which the radial drive propulsion system is mounted.

2. Description of the Prior Art

Many different types of propulsion systems for devices have been proposed and constructed over the course of history, including such varied systems as internal combustion engines connected to driven wheels, steam engines connected to paddles and propellers, and turbofan jet engines mounted on aircraft. Each of these types of propulsion systems, although designed for use in vastly different environments, share one common trait, and that is that they all exert force against a substance, be it air, sea or land, to produce the propulsive force driving the device. Currently, there is no universal mechanical propulsion device which can be used in each of the above situations and does not require a material or substance to “push” against to produce thrust.

Several examples of attempts to solve this problem are found in the prior art, and include Cook, U.S. Pat. No. 4,631,971, which discloses a device which employs centrifugal force for exacting linear motion via a pair of counter-rotating arms and Zachystal, U.S. Pat. No. 4,884,465, which discloses a device for obtaining a directional force from rotational motion that includes a weight connected to a frame which rotates about a transverse axis at an angular speed equal to that of the frame, and respectively traverses 180 degrees within a first half cycle of return oscillatory motion. Also, Redish, Canadian patent No. Ca 704568 discloses a device with counter-balancing radial arms that converts centrifugal energy into linear motion. However, each of the above-cited prior art devices include inherent deficiencies and thus do not completely solve the problems presented in translating rotational motion to radial motion for providing device thrust. There is therefore a need for a propulsion system which will efficiently convert rotational energy into radial energy which can be used to provide thrust to the device in which the propulsion system is mounted.

Therefore, an object of the present invention is to provide an improved radial drive propulsion system.

Another object of the present invention is to provide a radial drive propulsion system which includes at least one oscillator arm and weight which is driven to oscillate thus producing force along the axis of the oscillator arm.

Another object of the present invention is to provide a radial drive propulsion system which includes a drive motor, at least one radial propulsion unit including a drive arm, a translation arm extending forwards and inwards from the drive arm, and an oscillator unit having a swivel base and oscillator arm and weight extending forwards from the swivel base and a gearbox section for transferring power from the drive motor to the drive arm of the radial propulsion unit such that rotation of the drive arm is translated by the translation arm and oscillator unit into radial motion of the oscillator arm thus producing radial force for propelling the device on which the radial drive propulsion system is mounted.

Another object of the present invention is to provide a radial drive propulsion system which does not require matter to “push” against to produce forward thrust.

Another object of the present invention is to provide a radial drive propulsion system which is at least as efficient as those propulsion devices found in the prior art.

Another object of the present invention is to provide a radial drive propulsion system which, although requiring heavy-duty construction materials for construction due to the extreme forces which are encountered during operation of the present invention, is far more simple to operate and maintain than those devices found in the prior art.

Finally, an object of the present invention is to provide a radial drive propulsion system which is durable in manufacture and which is safe and durable in use.

### SUMMARY OF THE INVENTION

The present invention provides a radial drive propulsion system for devices which includes a base frame and a rotatably mounted drive shaft mounted on the base frame. A drive arm is mounted on the drive shaft, the drive arm extending generally perpendicularly outwards from the drive shaft and having an outer end. A translation arm includes a rearward end mounted on the outer end of the drive arm, the translation arm extending generally inwards and forwards from the outer end of the drive arm. A swivel-mounted oscillator unit includes a generally upright oscillator base having a lower end rotatably mounted on the base frame forward of the drive arm, the forward end of the translation arm being pivotably connected to the upper end of the oscillator base. The oscillator unit further includes an oscillator arm having a rearward end mounted on the generally upright oscillator base and extending forwards therefrom, and a forward end on which is mounted an oscillator weight. The drive shaft, the drive arm, the translation arm and the oscillator unit all cooperate such that rotation of the drive shaft causes the drive arm to spin thus causing the translation arm to drive the oscillator base to swivel thus causing the oscillator arm and the oscillator weight to oscillate thereby translating the rotary energy of the drive shaft into radial energy of the oscillator unit.

The radial drive propulsion system as thus described clearly offers several advantages over those devices found in the prior art. First of all, the present invention is a universal propulsion system that can be adapted to propel and/or provide directional thrust to virtually any type of land vehicle, boat, ship, aircraft or other device or vehicle requiring thrust, and can be powered by a conventional engine or motor. Furthermore, the invention employs mechanical oscillators to create radial energy that can be used for propulsion and this method is superior to, or compares favorably with, other drive systems mechanically, having an efficiency of about 80%, particularly when compared with wheel-driven vehicles. In the case of an automobile or similar vehicle, no transmission differential or drive axle is required, resulting in lower cost and safer operation, particularly as the wheels are not driven, which eliminates spinning of the vehicle's tires in reduced friction environments such as on snow or ice. Also, the radial drive propulsion system of the present invention can be reversed for braking purposes, to enhance standard braking systems. When the present invention is used in connection with boats and ships, the invention is more efficient, of lower cost, and much safer than the commonly-used exposed screws and jets. The present invention can also be used effectively on aircraft and furthermore is the only mechanical propulsion system known to the inventor that can be used in outer space. The present invention thus provides a substantial improvement over those devices found in the prior art.

### BRIEF DESCRIPTION OF THE DRAWINGS

FIG. 1 is a perspective view of the radial drive propulsion system of the present invention;

FIG. 2 is a top plan view of the present invention;

FIG. 3 is a side elevational view of the present invention;

FIG. 4 is a front elevational view of the present invention;

FIG. 5 is a detail perspective view of one radial oscillator unit of the present invention;

FIG. 6 is a detail top plan view of the radial oscillator unit of FIG. 5 of the present invention showing the elements thereof;

FIG. 7 is a detail side elevational view of the radial oscillator unit of FIG. 5 of the present invention;

FIG. 8 is a detail front elevational view of the radial oscillator unit of FIG. 5 of the present invention;

FIG. 9 is an exploded perspective view of the oscillator arm and base of the radial oscillator unit of FIG. 5 of the present-invention;

FIGS. 10A and 10B are, respectively, detail front and side elevational views of the drive arm of the radial oscillator unit of FIG. 5 of the present invention;

FIG. 11 is an exploded perspective view of the drive arm of the radial oscillator unit of FIG. 5 of the present invention;

FIG. 12 is a detail front elevational view of the translation arm of radial oscillator unit of FIG. 5 of the present invention;

FIG. 13 is an exploded perspective view of the translation arm of the radial oscillator unit of FIG. 5 of the present invention;

FIG. 14 is a detail perspective view of the gearbox section of the present invention;

FIG. 15 is an exploded detail perspective view of the gearbox section of the present invention;

FIG. 16 is a detail top plan view of the radial oscillator units in operation showing the motion of the oscillator arm and weight;

FIG. 17 is a detail top plan view of the radial oscillator unit showing the critical dimensions of the present invention;

FIG. 18 is a detail top plan view of the reversing mechanism of the present invention;

FIGS. 19 and 20 are diagrams illustrating the velocities and forces produced by operation of the present invention; and

FIG. 21 is a detail perspective view of an alternative embodiment of the gearbox section of the present invention which includes belts in place of the gears.

### DESCRIPTION OF THE PREFERRED EMBODIMENT

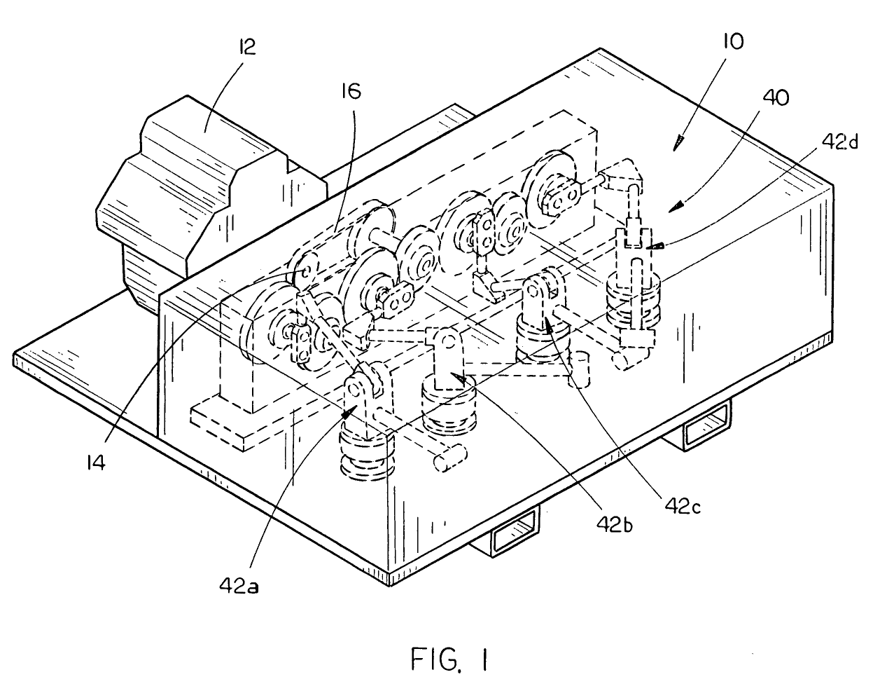

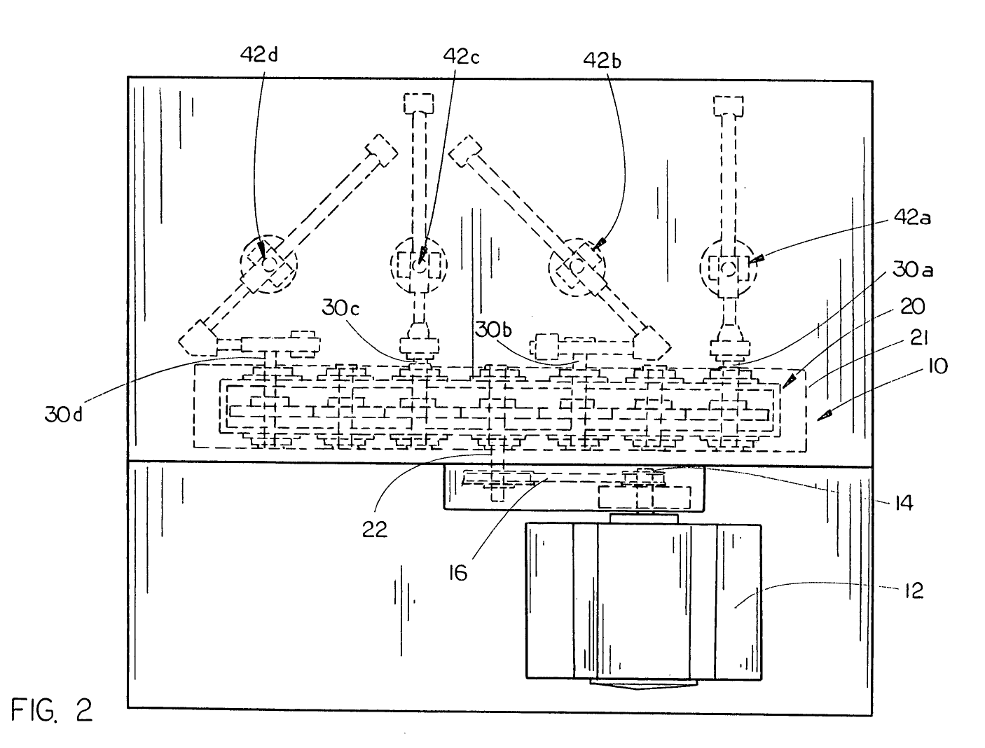

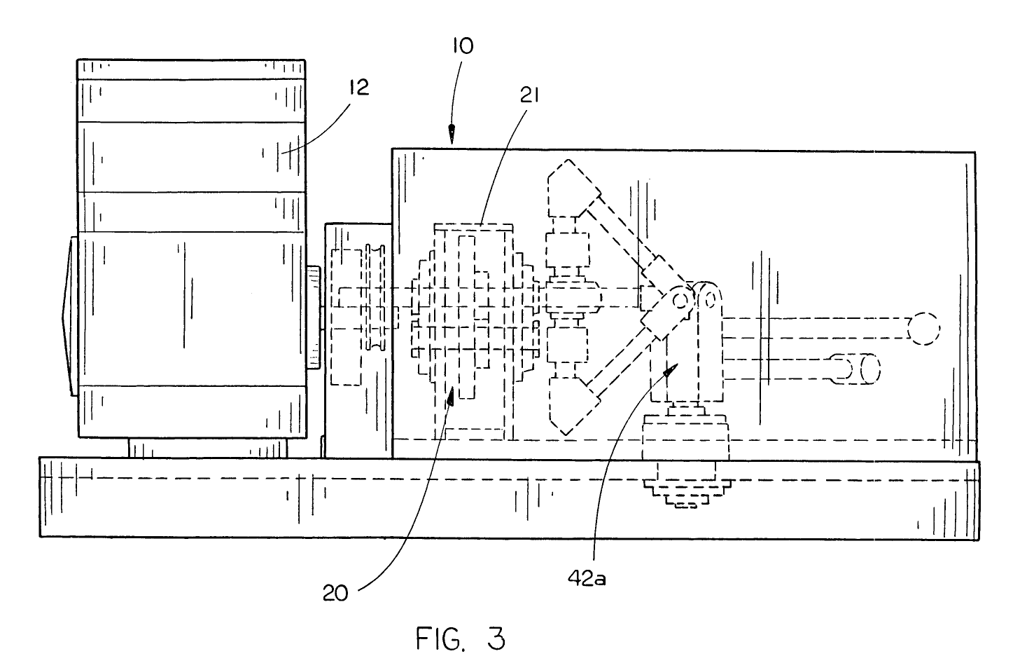

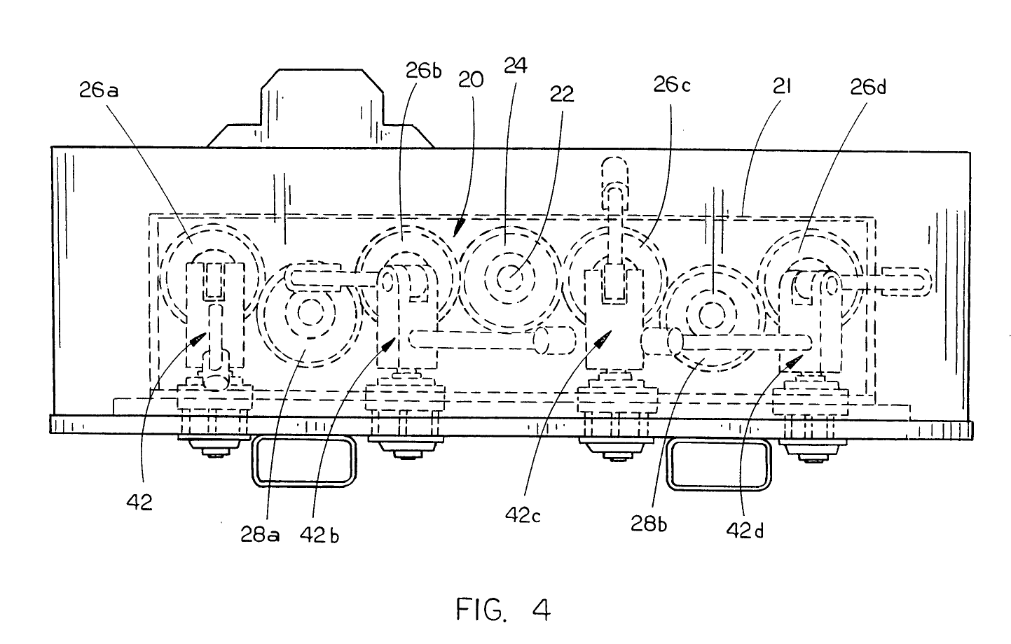

The radial drive propulsion system 10 of the present invention is shown best in FIGS. 1-4 as including three main sections, the first being the drive motor 12, the second being the gearbox section 20, and the third being the propulsion section 40. In the preferred embodiment, the drive motor 12 could be constructed as any of various types of engines, including internal combustion engines, electric motors, and any other appropriate type of drive motor which can be used to drive the remaining elements of the radial drive propulsion system 10 of the present invention. The power output from drive motor 12 would preferably be via a drive shaft 14 which is connected to gearbox section 20 via a belt 16 which connects to main drive shaft 22, as shown best in FIGS. 1 and 2.

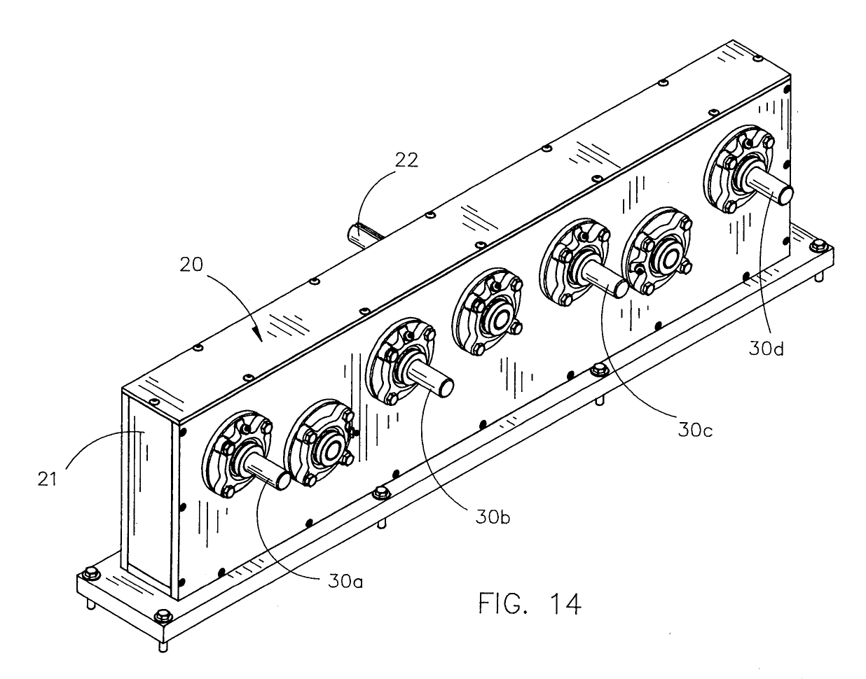

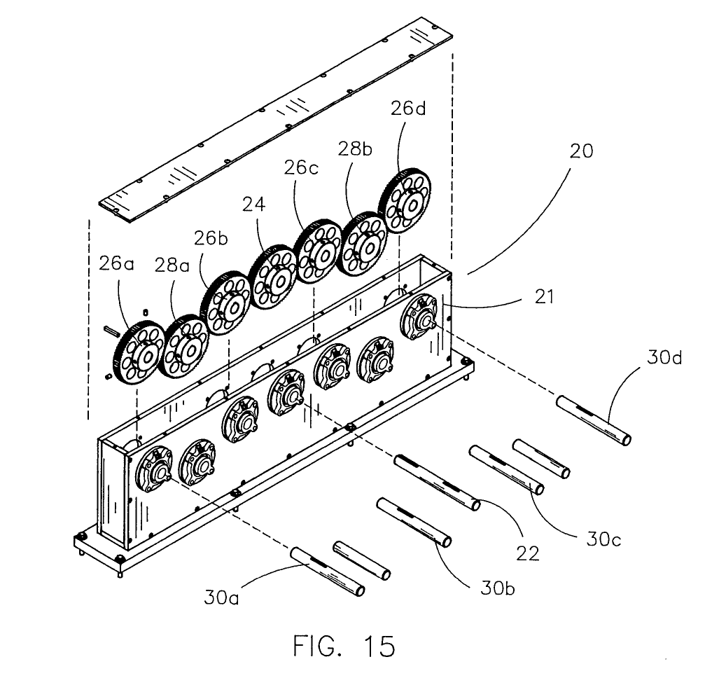

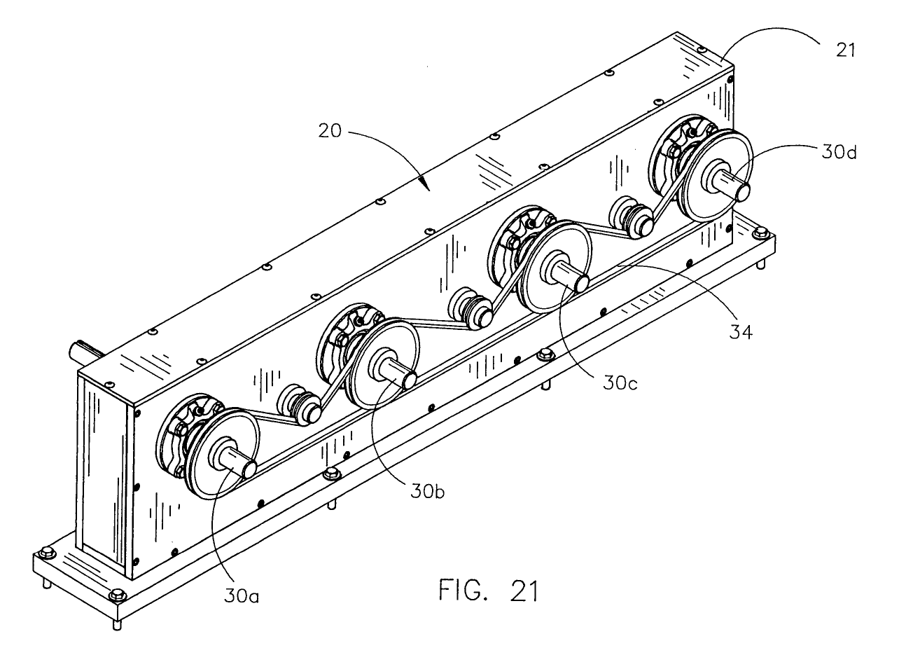

The gearbox section 20 includes main drive shaft 22 which is preferably connected directly to main drive gear 24, the main drive shaft 22 and main drive gear 24 being rotatably mounted within gearbox section 20, specifically within gearbox enclosure 21, as shown best in FIGS. 14 and 15. The main drive gear is preferably centrally located within gearbox enclosure 21, although the precise location of main drive gear 24 is not critical to the present invention so long as it is capable of driving the secondary drive gears 26a, 26b, 26c, and 26d, as also shown in FIGS. 1 and 2. Due to spacing requirements, it may be necessary to include a plurality of translational drive gears 28a and 28b which transfer the rotational force of main drive gear 24 to the secondary drive gears 26a and 26d. Of course, it should be noted that numerous other variations of gears, belts, and chains may be used to transfer rotational force from main drive gear 24 to secondary drive gears 26a-d, each of which would be understood by those skilled in the art. For example, the secondary drive gears 26a-d may be driven off of main drive gear 24 by a pulley or belt 34 as shown best in FIG. 21. Also, the exact size and shape of each of the main drive gear 24, secondary drive gears 26a-d, and translational drive gears 28a and 28b is only critical to the present invention in that the rotational force of motor drive shaft 14 driving main drive shaft 22 be translated to each of the secondary drive gears 26a-d. Also, it should be noted that each of the main drive gear 24, secondary drive gears 26a-d, and translational drive gears 28a and 28b are mounted such that their axis of rotation are generally parallel with one another and with adjacent drive gears in intermeshing connection for transfer of rotational force there between.

The propulsion section 40 is shown best in FIGS. 1-4 as including four generally identical radial propulsion units 42a, 42b, 42c, and 42d which are each connected to one of the secondary drive gears 26a-d. As each of the radial propulsion units 42a-d are generally identical, the following description of radial propulsion unit 42a should be understood to apply equally to each of the remaining radial propulsion units 42b, 42c, and 42d, with the only difference between the units being their location on base platform 100.

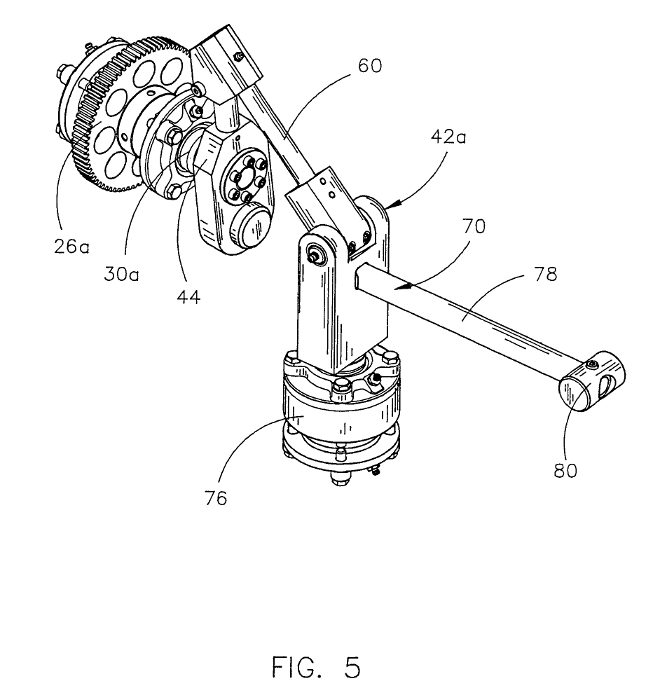

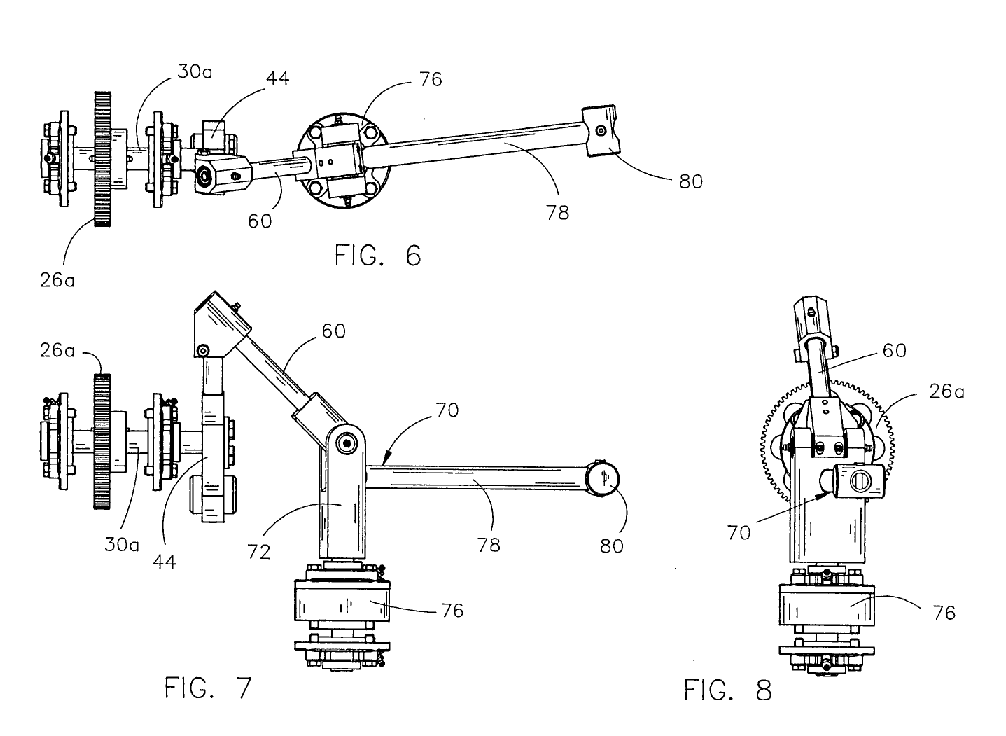

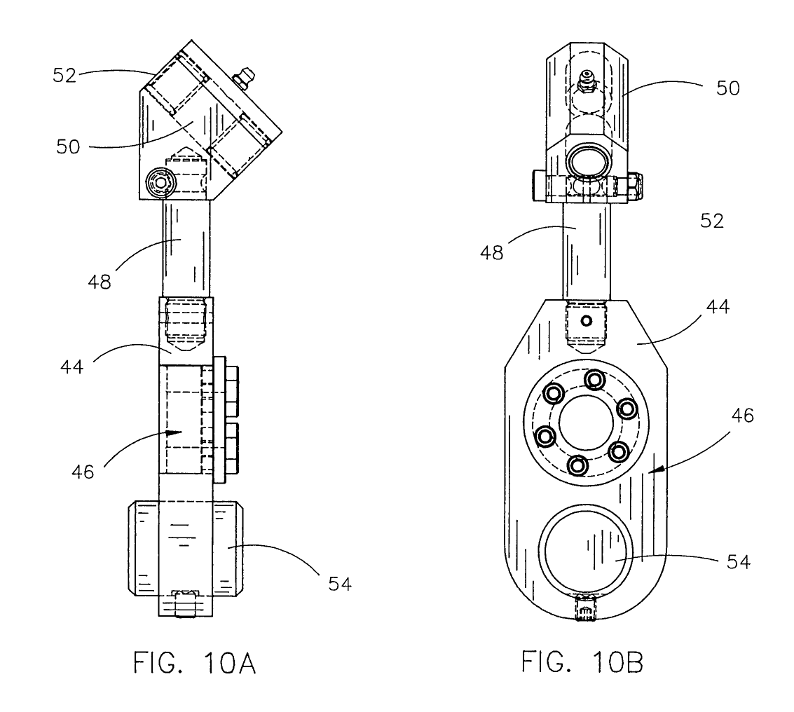

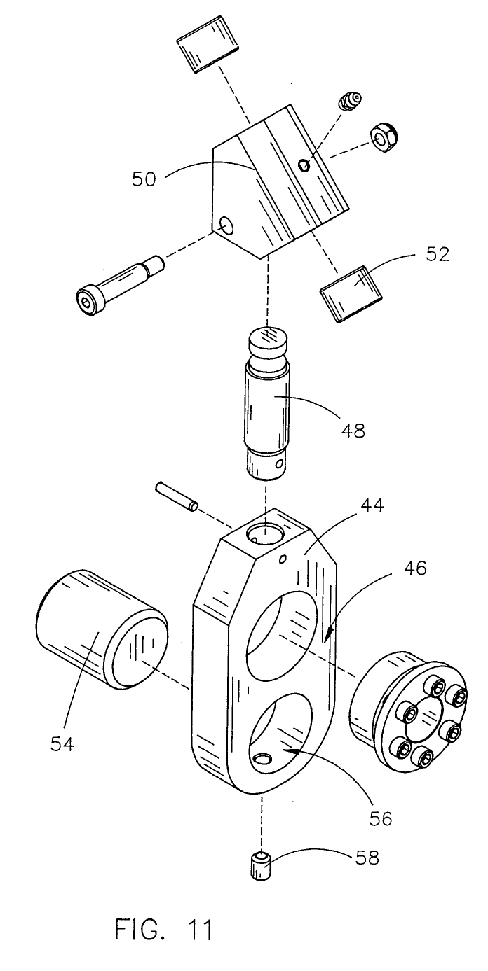

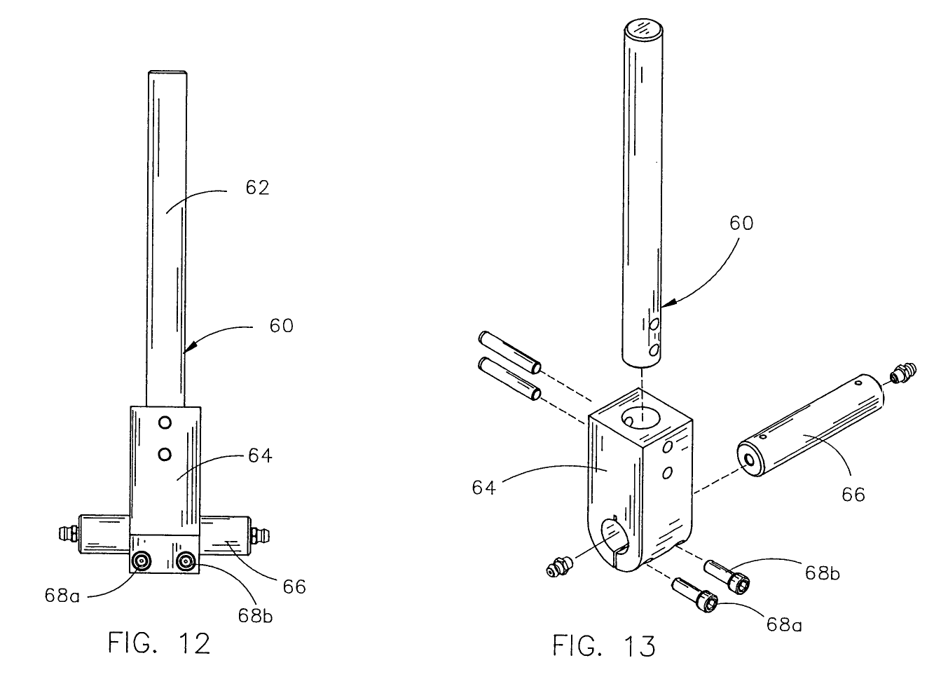

Radial propulsion unit 42a is best shown in FIGS. 5-13 as including a drive arm 44 mounted on the end of secondary drive shaft 30a and extending generally perpendicular thereto. FIG. 11 best illustrates the construction of drive arm 44, which would preferably include a main shaft connection section 46, a central drive arm section 48, and a translation arm connection bracket 50 which includes a translation arm connection sleeve 52. Although FIG. 11 shows the connection of central drive connection section 48 to the main shaft connection section 46 as being via a pin and sleeve combination and to translation arm connection bracket 50 via translation arm connection sleeve 52, it should be noted that various other types of connections may be used with the present invention, such as bolts, welding, or any other such connection method so long as the structural strength and integrity of the drive arm 44 is maintained.

One other critical feature of the drive arm 44 is the counterweight 54 which is mounted in the lower section of main shaft connection section 46 within counterweight recess 56, the counterweight 54 being secured within the counterweight recess 56 via a set screw 58, a pin and sleeve securement combination, nut and bolt securement combination, welding or any other the like. The size, shape and mass of the counterweight 54 will be determined on a case-by-case basis depending on the amount of weight needed to counter-balance the opposite section of drive arm 44 and the translation arm 60, which will be described herein. Furthermore, it should be noted that the drive arm 44 and counterweight 54 may be replaced by any appropriately designed structure, such as a counter-weighted disk or any other structure that will perform the same general functions. Likewise, the remaining structures defined herein may be substituted with other similarly performing structures so long as the functionality of the unit is maintained.

The translation arm 60 is best shown in FIGS. 5, 12, and 13 as including a main translation arm shaft 62 which extends into and is connected to translation arm pivot bracket 64, the connection between translation arm main shaft 62 and translation arm pivot bracket 64 being via a pin and sleeve combination, nut and bolt combination or welding, depending upon the construction materials used in connection with the present invention. In the preferred embodiment, translation arm 60 would extend at a 45° angle from translation arm connection bracket 50 on drive arm 44, with translation arm main shaft 62 being secured within translation arm connection sleeve 52, as shown best in FIG. 5. It should be noted, however, that the exact angle of translation arm 62 relative to drive arm 44 is only critical in that the length of translation arm 60 be sufficient to place the pivot axis of translation arm to pivot bracket 64 at the same height as the rotational axis of drive arm 44 as mounted on secondary drive shaft 30a. Therefore, in some instances it may be preferable to include a translation arm 60 having a greater length than described in connection with the preferred embodiment shown in the attached figures should a decreased range of motion for the radial propulsion unit 42a be desired. Of course, such modifications would be understood by one skilled in the art and familiar with the present invention and the numerous variations and possibilities need not be discussed herein for that reason.

Mounted within and extending through translation arm pivot bracket 64 is a pivot bearing shaft 66 which defines the pivot axis of translation arm pivot bracket 64 and would preferably include ball bearings or some other type of friction-reducing element within the pivot bearing shaft 66. Once the pivot bearing shaft 66 is secured within the translation arm pivot bracket 64, securement bolts 68a and 68b would be inserted into threaded holes for tightening the translation arm pivot bracket 64 on pivot bearing shaft 66, thus securing it therewithin.

FIGS. 5-9 illustrate the oscillator unit 70 of the present invention, which provides the driving force-producing section of the present invention. In the preferred embodiment, oscillator unit 70 would include a generally upright propulsion unit base 72 extending downwards from which is a propulsion unit base shaft 74 which extends downwards into and is retained within a heavy-duty swivel mount 76, the swivel mount 76 operative to permit the propulsion unit base shaft 74 and propulsion unit base 72 to rotate about an axis generally defined by the propulsion unit base shaft 74. The preferred back-and-forth swivelling motion of the oscillator unit 70 is thus permitted which is required to produce the propulsion force of the present invention. Extending outwards generally perpendicular to and mounted on the propulsion unit base 72 is an oscillator arm 78, the oscillator arm 78 further including an oscillator weight 80 mounted on the outer end thereof via a securement bolt 82 or any other appropriate connection. In the preferred embodiment, the oscillator arm 78 would have a length of approximately six inches to two feet and the oscillator weight 80 would have a mass of between six ounces and two pounds, depending on the force which is intended to be produced by the present invention. Also, due to the extreme forces endured by the oscillator arm 78 and oscillator weight 80, the size, shape and mass of the elements described above may be modified or changed to obtain maximum efficiency. Also, it should be noted that the size, shape, and design of the propulsion unit base 72 may be modified or changed, depending on the specific design requirements of the particular embodiment of the present invention. Such modifications would be understood by those skilled in the art of metallurgy and are incorporated into this disclosure.

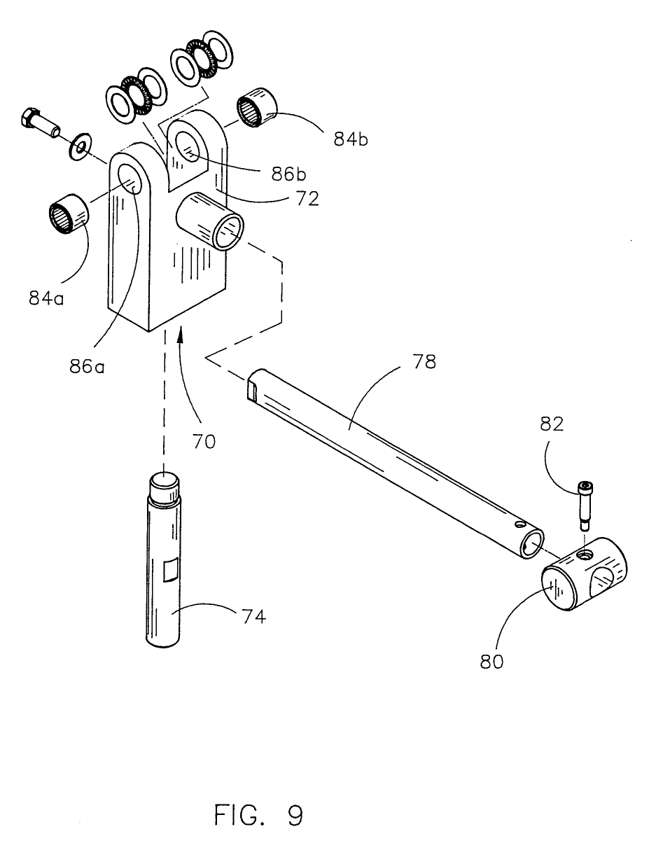

The connection of pivot bearing shaft 66 of translation arm pivot bracket 64 to the propulsion unit base 72 is shown best in FIG. 9 as including a pair of bearing sleeves 84a and 84b which fit within shaft securement sleeves 86a and 86b such that the pivot bearing shaft 66 fits within the shaft bearing sleeves 84a and 84b supported within shaft securement sleeves 86a and 86b so that the pivot bearing shaft 66 may rotate freely within the shaft bearing sleeves 84a and 84b, thus permitting the translation arm 60 to pivot relative to propulsion unit base 72 during rotation of secondary drive shaft 30a. It should also be noted, however, that the precise connection between translation arm 60 and propulsion unit base 72 is not critical so long as the translation arm 60 may pivot relative to propulsion unit base 72, as shown in FIGS. 5-9.

The following description of the motion of radial propulsion unit 42a, as shown in FIG. 5, should be understood to apply equally to the remaining radial propulsion units 42b, 42c, and 42d, with the only modification being that the exact height and location of the other radial propulsion units 42b-d may be modified or changed, depending upon the vehicle or device in which the radial drive propulsion system 10 of the present invention is to be mounted. In operation, radial propulsion unit 42a functions as follows: Rotation of secondary drive gear 26a results in rotation of secondary drive shaft 30a, which is connected directly to drive arm 44. Drive arm 44 is then rotated about the axis defined by secondary drive shaft 30a, thus rotating translation arm 60 along with drive arm 44. The translation arm main shaft 62 rotates within translation arm connection sleeve 52 to permit the ongoing rotation of drive arm 44 and translation arm 60, and the rotational motion of the drive arm 44 and translation arm 60 causes the swiveling of propulsion unit base 72 and hence oscillator arm 78 and oscillator weight 80 about propulsion unit base shaft 74 and heavy-duty swivel mount 76.

Due to the pivoting connection between translation arm 60 and propulsion unit base 72, the rotation of drive arm 44 produces radial motion of oscillator arm 78 and oscillator weight 80, with the motion of the oscillator arm 78 relating to the motion of drive arm 44 in the following manner. Beginning with the drive arm 44 in the twelve o'clock noon position, the translation arm 60 and propulsion unit base 72 face directly forward along the axis defined by the secondary drive shaft 30a. As drive arm 44 reaches approximately the three o'clock position, translation arm 60 has rotated within translation arm connection sleeve 52 approximately 90° and propulsion unit base 72 has been rotated through an angle equal to the angle between the drive arm 44 and translation arm 60. As the drive arm 44 continues to rotate to the six o'clock position, the translation arm 60 and propulsion unit base 72 return to the center position with the oscillator arm 78 projecting outwards from the propulsion unit base 72 along a line generally defined by the secondary drive shaft 30a. It is at this point that the speed of the oscillator arm 78 is at its maximum, at least in this embodiment, and thus the force produced by the oscillator arm 78 and oscillator weight 80 is also at its maximum. Continued rotation of drive arm 44 to the nine o'clock position thus forces the translation arm 60 and hence propulsion unit base 72 to the position furthest to the left of the secondary drive shaft 30a in a position separated by 90° from the position given when the drive arm 44 is at the three o'clock position. Finally, as the drive arm 44 continues to rotate to the twelve o'clock position, the entire process repeats and the oscillating motion of the oscillator arm and oscillator weight 80 is produced.

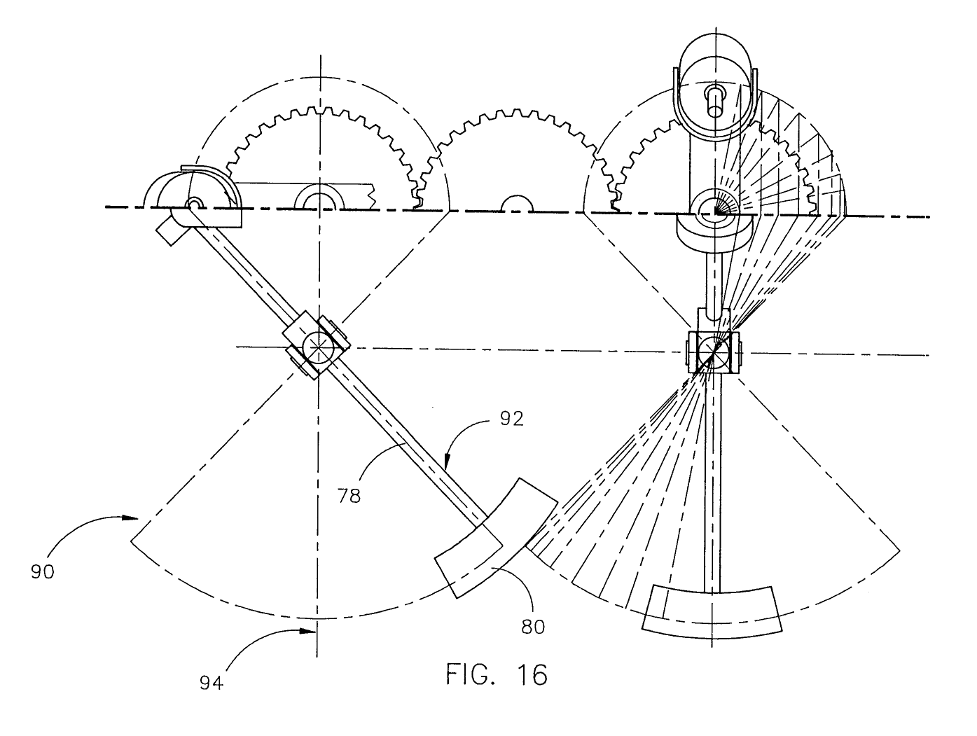

A critical feature of the present invention is that the oscillations of oscillator arm 78 and oscillator weight 80 are within and defined by a single plane, and during each oscillation cycle, the oscillator arm 78 and oscillator weight 80 accelerate from the left-most and right-most stop points 90 and 92 (as shown best in FIG. 16) towards the center 94 of the arc of travel of the oscillator arms 78 and oscillator weight 80. This acceleration to the mid-point of the arc and deceleration thereafter during the oscillation cycle creates the forward radial force of the present invention in much the same way as if a person were swinging a weight forward resulting in a forward force being felt by the person swinging the weight.

As is further shown in FIG. 16, it is preferred that the radial propulsion units 42a and 42b work in conjunction with one another such that when one of the radial propulsion units 42a is at its left-most or right-most stop 90 and 92 on its arc of travel, the related radial propulsion unit 42b is at the center point 94 of the arc. In the preferred embodiment, each additional set of two oscillators should reflect the same relationship as radial propulsion units 42a and 42b. It is believed that this will dampen harmonic vibrations caused by the rapid motion of the oscillator arm 78 and oscillator weight 80 of the radial propulsion units 42a, 42b, 42c, and 42d. This feature, however, is not the most important benefit of coupling the radial propulsion units 42a and 42b. Rather, in addition to dampening harmonic vibrations, the coupling of the radial propulsion units 42a and 42b actually increases the efficiency of the entire radial drive propulsion system 10 due to the transfer of energy between the coupled radial propulsion units 42a and 42b via the intermeshing secondary drive gears 26a and 26b. Stated succinctly, as one of the coupled radial propulsion units 42a is slowing down, a portion of the energy released by the slowing unit is transferred via the intermeshing secondary drive gears 26a and 26b to the other of the coupled radial propulsion units 42b which assists the unit in speeding up. The energy transfer between the coupled radial propulsion units 42a and 42b greatly increases the efficiency of the present invention in that at least some of the work necessary to accelerate the oscillator arm 78 and oscillator weight 80 of the radial propulsion units 42a, 42b, 42c, and 42d to the speeds necessary to produce thrust is provided by the units themselves through the coupling arrangement. Of course, numerous variations of these arrangements of elements may be used with the present invention so long as the intended purposes of efficiently transferring energy between propulsion units and dampening harmonic vibrations are achieved.

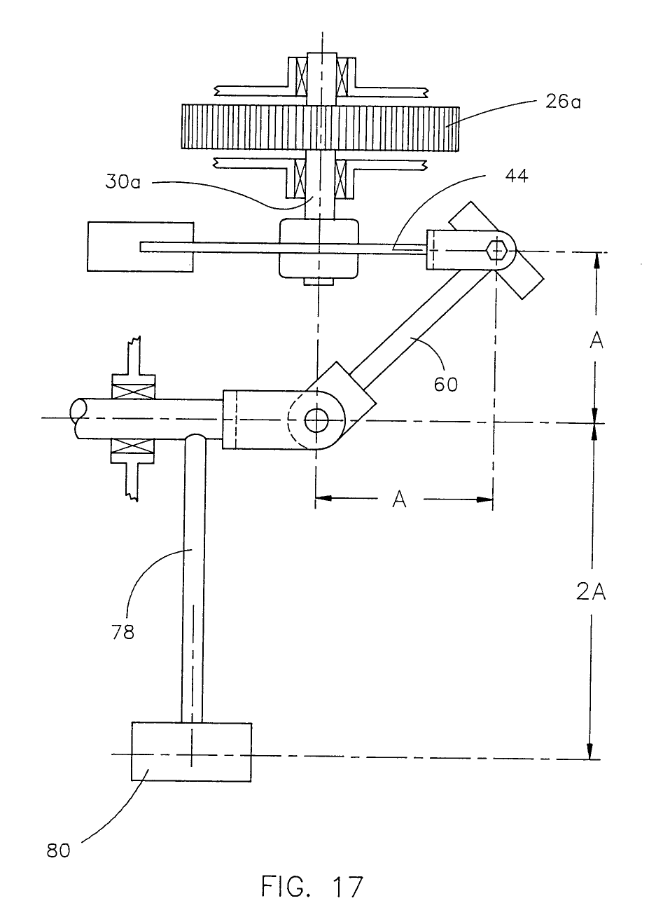

To illustrate the theoretical force production estimates of the present invention, a hypothetical situation is proposed in which the following calculations are made. It should be noted, however, that although the numbers proposed are hypothetical only, they are within the parameters proposed for use with the present invention and, as such, should be understood to be illustrative of the typical operation of the present invention. FIGS. 16 and 17 show the configuration of the radial drive propulsion system 10 in a relatively simple form, including two radial propulsion units 42a and 42b indexed 45°s apart, which means that one unit is accelerating while the other is decelerating, thus providing energy balance in the unit. If it is assigned a value of six inches to dimension A, as shown in FIG. 17, a revolutions per minute speed of 1,800 to the drive arms 44 and an energy of 5,500 foot pounds to each oscillator at mid-oscillation, we obtain the following results. The following calculations are based on a hypothetical situation, but the methods used will hold true for other design requirements.
Calculation of the required mass of the oscillator weight and arm is performed in the following manner, given that the required configuration for this situation is that the radius of gyration be 12.00 inches:
   If E=(MV²)/2 then M=2E/V²
   Where:

E=energy in ft-lb—5500

M=mass

V²=35531.27

M=2(5500)/35531.27=0.309586 lbs.

Calculate force required to accelerate oscillator from 0 to 188.4974 FPS in 0.008333 seconds:
F=MV/t
Where:

F=force in lbs

M=mass=0.309586

V=velocity in FPS at end of time t=188.4974

T=time in seconds for oscillator to move 45°=0.008333
F=(0.309586)(188.4974)/(0.008333)=7003 lbs of force
Calculate work required to move oscillator from 0 to 188.4974 FPS:
W=F×d
Where:

F=force in lbs=7003

W=work in ft-lbs

d=distance in ft=length of 45° arc of oscillator travel=0.7854
W=(7003)(0.7854)=5500 ft-lbs

Each oscillator has an energy of 5500 ft-lbs at mid-oscillation and this energy is turned back into the system as the oscillator de-accelerates from 188.4974 FPS to 0, furnishing the 5500 ft-lbs required to accelerate the other, minus friction losses.

The maximum centrifugal force at each oscillator occurs at mid-oscillation:
F_{c}=MV²/R
Where:

F_{c}=centrifugal force in lbs

M=mass=309586

V=velocity in FPS=188.4974

R=radius in ft=1
F_{c}=(0.309586)(35531.27)/1=11000
average F_{c}=11000/2=5500
Determine radial energy associated with F_{c}:
If E=MV²/2 and F_{C}=MV²/R then F_{c}=2E/R=E/0.5R and F_{c}(0.5R)=E

R=1 and 0.5R=0.5 therefore 5500 (0.5)=2750 ft-lbs=average radial energy.

As indicated, the energy that causes radial motion is drawn from the energy of rotary motion, therefore, an additional 2750 ft-lbs of energy must be introduced into the system at each oscillator, to sustain both radial and rotary motion.

Because the oscillators are in dynamic balance, the initial power input before radial motion has begun is only that amount required to overcome friction losses in the system, or in this instance, about ¾ HP or 412.5 ft-lbs energy for both oscillators.
Average energy in each oscillator=5500/2=2750 ft-lbs
Converted to ft-lbs per second, then 2750/550=5 HP

This ratio of the chord to the arc of a 90° circle segment=0.90 and represents the proportion of radial energy directed parallel to the center of oscillation.
5 HP(0.90)=4.5 HP
4.5(2)=9 HP=radial HP output

The energy in the propulsion system=5500 ft-lbs that are balanced+5500 ft-lbs that are unbalanced=11000 ft-lbs total.

11000/550=20 HP=basis for calculating friction losses.

A conservative estimate of the efficiencies of machine parts is as follows:
The efficiency of gear with bearings=0.96
The efficiency of ball bearings=0.99
   Total efficiency=0.96×0.99×0.99×0.99=0.9315
   20 HP/0.9315=21.47=1.47 MP friction loss
   Actual HP input=10+1.47=11.47 HP
   9 HP output/11.47 HP input=0.7847=efficiency
   9 HP×550=4950 ft-lbs energy to move device.

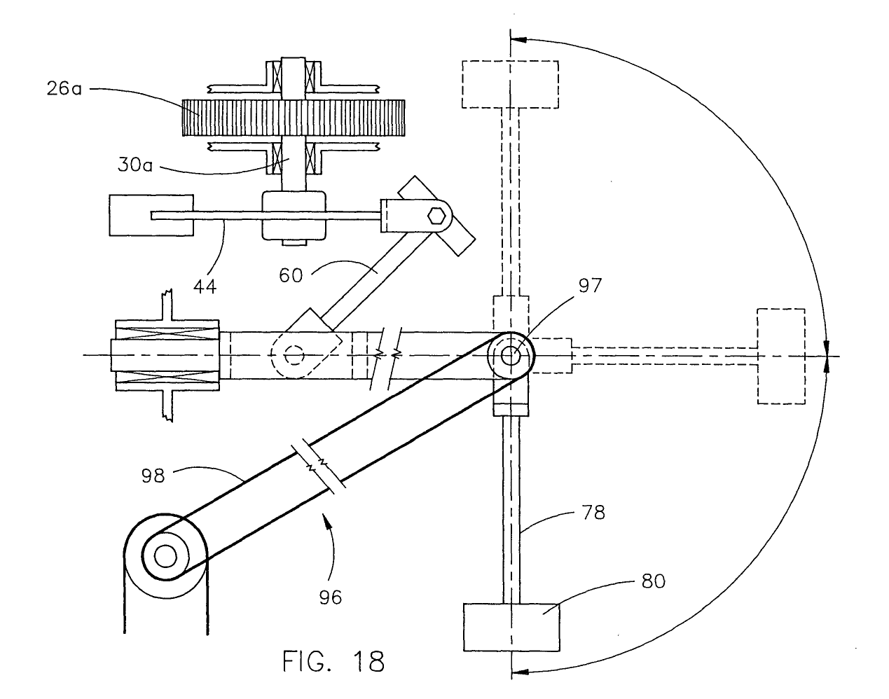

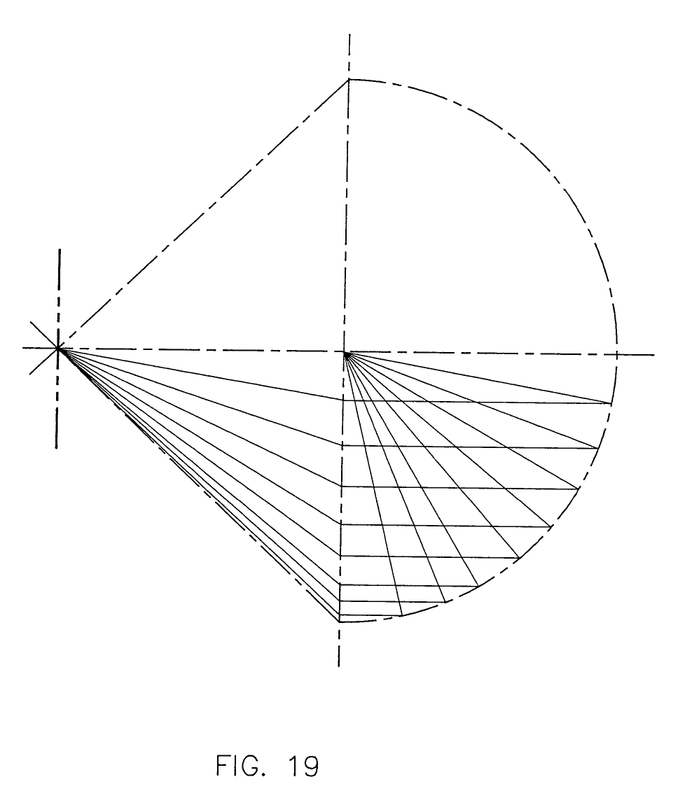

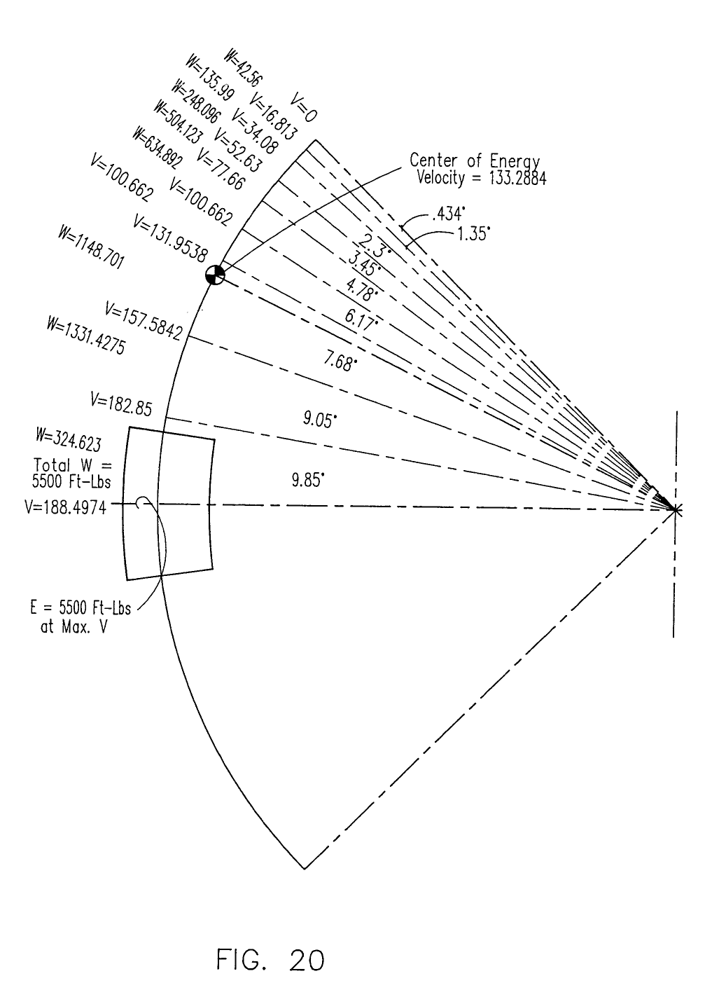

FIG. 18 illustrates the reversing mechanism 96 of the weight 80 are mounted on a pivot 97 which permits rotation of the oscillator arm 78 through 180° to result in operation of the unit in the opposite direction, thus providing either a braking force or a reversing force to the device in which the present invention is mounted. In the preferred embodiment, the reversing mechanism 96 would include a belt or chain device which, when engaged, would cause the oscillator arm 78 to rotate about pivot point 97 to permit reverse motion of the oscillator arm 78. The ability of the present invention to be reversed is a substantial improvement over those devices found in the prior art, and will greatly assist in the deceleration of the device in which the radial drive propulsion system 10 of the present invention is mounted. Of course, many other types of mechanisms for reversing the motion of the oscillator arm 78 may be included with the present invention so long as the intended object of changing the direction of motion of the oscillator arm 78 is achieved.

The critical feature of the present invention is the conversion of rotational motion of the motor, gearbox, drive shaft etc. into the radial motion of the oscillator arm 78 and oscillator weight 80 which produces the forward force of the present invention. To this end, therefore, the exact mechanism by which the oscillator arms 78 and oscillator weights 80 are driven to produce the oscillating motion may be modified or changed, particularly when such change will result in an increase in efficiency, safety or both.

It should be noted that the excessive forces encountered by the present invention during the operation of the invention will likely require the use of extremely durable construction materials, including titanium-based alloys and other such alloys with very high tensile strengths and relatively low weight. One need only review the expected operational figures presented above to realize that the components of the radial drive propulsion system 10 of the present invention will be under extreme stress during operation, and therefore, the use of heretofore unknown yet extremely strong construction materials is contemplated, as is the use of any and all appropriate construction materials available at present.

It is to be understood that numerous additions, substitutions and modifications may be made to the radial drive propulsion system of the present invention which fall within the intended broad scope of the appended claims. For example, the size, shape and dimensions of each of the elements of the invention may be changed or modified so long as the functional characteristics of the invention are maintained. Furthermore, the materials used in construction of the invention may be modified should superior materials be designed or discovered, so long as the extreme durability requirements of the present invention are fulfilled by the substituted construction material. Also, the number and location of the radial propulsion units 42a-d relative to the drive motor 12, gearbox section 20 and other radial propulsion units 42a-d may be modified and changed depending upon the propulsion characteristics desired in use of the present invention. Finally, the precise locations and connections of elements of the invention described above and shown in the accompanying drawings may be modified within the scope of the claims should such modification prove desirable.

There has therefore been shown and described a radial drive propulsion system which accomplishes at least all of the stated objectives.

1. A radial drive propulsion system for devices comprising:
a base frame;
drive means mounted on said base frame;
a radial propulsion unit including;
at least one swivel-mounted oscillator unit including;
an oscillator unit base rotatably mounted on said base frame;
a weighted oscillator arm having a rearward end mounted on said oscillator unit base and extending forwards therefrom, and a forward weighted end; and
translation means connecting said drive means and said at least one swivel-mounted oscillator unit, said translation means operative to translate movement of said drive means into oscillating motion of said at least one swivel-mounted oscillator unit thereby translating the motion energy of said drive means into radial energy of said oscillator unit.

2. The radial drive propulsion system of claim 1 wherein said drive means is selected from the group comprising an internal combustion engine, an electric motor, a jet engine, a turbofan engine, a steam engine and a hybrid gas/electric motor.

3. The radial drive propulsion system of claim 1 further comprising a gearbox section driveably connected to said drive means, said gearbox section including a main drive shaft operatively connected to a main drive gear, said main drive shaft and main drive gear rotatably mounted within said gearbox section.

4. The radial drive propulsion system of claim 3 wherein said gearbox section further comprises at least one secondary drive gear driveably connected to said main drive gear such that rotation of said main drive gear drives rotation of said at least one secondary drive gear.

5. The radial drive propulsion system of claim 4 wherein said translation means comprises a drive arm operatively connected to said secondary drive gear and extending generally parallel with and spaced from said secondary drive gear and having an outer end and a translation arm extending from said outer end of said drive arm at an acute angle from said drive arm such that an outer end of said translation arm is generally aligned with the axis of rotation of said drive arm and is pivotably and rotatably connected to said at least one oscillator unit at said oscillator unit base such that rotation of said secondary drive gear rotates said drive arm pivoting and rotating said translation arm to translate rotational motion of said secondary drive gear to oscillating motion of said oscillator unit base.

6. The radial drive propulsion system of claim 1 wherein said oscillator unit base of said at least one swivel-mounted oscillator unit comprises a generally upright propulsion unit base and a propulsion unit base shaft extending downwards therefrom, said propulsion unit base shaft extending downwards into and being retained within a swivel mount operative to permit said propulsion unit base shaft and said propulsion unit base to rotate about an axis generally defined by said propulsion unit base shaft.

7. The radial drive propulsion system of claim 1 comprising two swivel-mounted oscillator units operatively connected with one another such that rotational acceleration of one of said two swivel-mounted oscillator units results in rotational deceleration of the other of said two swivel-mounted oscillator units such that energy is transferred between said two swivel-mounted oscillator units for improved efficiency of said radial drive propulsion system.

8. A radial drive propulsion system for devices comprising:
a base frame;
drive means mounted on said base frame, said drive means including a rotatably mounted drive shaft driven by said drive means;
a radial propulsion unit including;
a drive arm mounted on said drive shaft and having an outer end, said drive arm extending generally perpendicularly outwards from said drive shaft;
a translation arm having a rearward end mounted on said outer end of said drive arm and a forward end, said translation arm extending generally inwards and forwards from said outer end of said drive arm;
a swivel-mounted oscillator unit including;
a generally upright propulsion unit base having a lower end rotatably mounted on said base frame forward of said drive arm and an upper end, said forward end of said translation arm pivotably connected to said upper end of said propulsion unit base;
an oscillator arm having a rearward end mounted on said generally upright propulsion unit base and extending forwards therefrom, and a forward end; and
an oscillator weight mounted on said forward end of said oscillator arm; and
said drive shaft, said drive arm, said translation arm and said oscillator unit of said radial propulsion unit cooperating such that rotation of said drive shaft causes said drive arm to spin thus causing said translation arm to drive said oscillator base to swivel thus causing said oscillator arm and said oscillator weight to oscillate thereby translating the rotary energy of said drive shaft into radial energy of said oscillator unit.

9. The radial drive propulsion system of claim 8 wherein said drive means is selected from the group comprising an internal combustion engine, an electric motor, a jet engine, a turbofan engine, a steam engine and a hybrid gas/electric motor.

10. The radial drive propulsion system of claim 8 further comprising a gearbox section operatively connected to said drive shaft, said gearbox section including a main drive shaft operatively connected to a main drive gear, said main drive shaft and main drive gear rotatably mounted within said gearbox section.

11. The radial drive propulsion system of claim 8 wherein said gearbox section further comprises at least one secondary drive gear driveably connected to said main drive gear such that rotation of said main drive gear drives rotation of said at least one secondary drive gear.

12. The radial drive propulsion system of claim 8 wherein said generally upright propulsion unit base comprises a propulsion unit base shaft extending downwards therefrom, said propulsion unit base shaft extending downwards into and being retained within a swivel mount operative to permit said propulsion unit base shaft and said propulsion unit base to rotate about an axis generally defined by said propulsion unit base shaft.

13. The radial drive propulsion system of claim 8 comprising two swivel-mounted oscillator units operatively connected with one another such that rotational acceleration of one of said two swivel-mounted oscillator units results in rotational deceleration of the other of said two swivel-mounted oscillator units such that energy is transferred between said two swivel-mounted oscillator units for improved efficiency of said radial drive propulsion system.

14. A radial drive propulsion system for devices comprising:
a base frame;
drive means mounted on said base frame, said drive means including drive shaft means for producing rotationally-directed force;
a radial propulsion unit including;
at least two swivel-mounted oscillator units, each of said at least two swivel-mounted oscillator units including;
an oscillator unit base rotatably mounted on said base frame;
a weighted oscillator arm having a rearward end mounted on said oscillator unit base and extending forwards therefrom, and a forward weighted end;
translation means connecting said drive shaft means of said drive means and said at least two swivel-mounted oscillator units, said translation means operative to translate rotational movement of said drive shaft means into oscillating motion of said at least two swivel-mounted oscillator units thereby translating the motion energy of said drive means into radial energy of said at least two oscillator units; and
said at least two swivel-mounted oscillator units each coupled in groups of two swivel-mounted oscillator units with acceleration of said weighted oscillator arm in one of said coupled swivel-mounted oscillator units causing deceleration of said weighted oscillator arm of the other of said coupled swivel-mounted oscillator units and vice-versa such that the efficiency of the radial drive propulsion system is increased.

15. A radial drive propulsion system for devices comprising:
a base frame;
drive means mounted on said base frame, said drive means including drive shaft means for producing rotationally-directed force;
a radial propulsion unit including;
at least one swivel-mounted oscillator unit including;
an oscillator unit base rotatably mounted on said base frame, said oscillator unit base rotatable through a maximum oscillating rotation of one hundred eighty degrees (180°);
an oscillator arm having a rearward end mounted on said oscillator unit base and extending forwards therefrom, and a forward end; and
translation means connecting said drive shaft means of said drive means and said at least one swivel-mounted oscillator unit, said translation means operative to translate rotational movement of said drive shaft means into oscillating motion of said at least one swivel-mounted oscillator unit thereby translating the rotational motion energy of said drive shaft means into radial energy of said at least one oscillator unit.
